(19) United States
(12) Patent Application Publication
(10) Pub. No.: US 2002/0072999 A1
(43) Pub. Date: Jun. 13, 2002

(54) System and method for providing integrated inventory control of time-sensitive inventory

(75) Inventors: William J. Andres, Coral Springs, FL (US); Gary L. Hawkins, Boulder, CO (US); Rodney D. Hedges, Longmont, CO (US); Bruce Ray Morgan, Lawerenceburg, KY (US); James J. Velasco, Boulder, CO (US)

Correspondence Address: Anne Vachon Dougherty, Esq., IBM CORPORATION, 3173 Cedar Road, Yorktown Heights, NY, 10598, US

(73) Assignee: International Business Machines Corporation, Armonk, NY (US)

(21) Appl. No.: 09/784,918

(22) Filed: Feb. 16, 2001

Related U.S. Application Data
(60) Provisional application No. 60/183,278, filed on Feb. 17, 2000.

(51) Int. Cl. G06F 17/60

(52) U.S. Cl. 705/28; 705/26

(57) ABSTRACT

A system and method for providing controlled inventory depletion of time-sensitive inventory comprising a front-end process for identifying time-sensitive inventory to be offered for selective sale; a sell off component for offering inventory for selective sale and for handling communications with prospective buyers; and a back-end process for automatically integrating the results of the selective sale into the yield and revenue management systems at the supplier site.

### FIELD OF THE INVENTION

The present invention relates generally to the tracking and disposal of time-sensitive inventory, and more particularly to a system for identifying time-sensitive inventory to be offered for selective sale, offering the inventory for selective sale, administrating selective sales over electronic media, and updating inventory related databases to reflect sales.

### BACKGROUND OF THE INVENTION

It had become standard practice for suppliers of time-sensitive inventory to take measures to rapidly dispose of the inventory as the “expiration” time approaches. Examples of such accelerated disposal include offering dated items such as film and vitamins for discounted prices. Similarly, time-sensitive services such as airline passage and freight hauling are increasingly being offered at discounted prices, rather than have the space go unused. The airline and hotel industries have embraced the Internet as a medium for offering otherwise unused space/tickets to bargain hunting buyers. Hosted web sites, such as e-bay* and priceline.com* (*may be trademarks of the respective users), provide a centralized site for the auctioning of goods and services over the Internet.

At present, there are several well-established hosted sites which barter the goods of others in an auction mode, whereby at least one variable in the sale of the goods is left to be “filled in” by either the consumer (i.e., the end user accessing the hosted site via the Internet) or the host (i.e., the auctioning service entity who is not the supplier of the good or service being auctioned). In the priceline.com model of reverse auctioning of goods and services, as detailed in U.S. Pat. No. 5,897,620 of Jay S. Walker, et al entitled “Method and Apparatus for the Sale of Airline-Specified Flight Tickets”, a consumer selects a “special fare listing” with flight departure and destination information and a specified time range for travel, along with a monetary amount comprising a “bid” for an airline ticket which meets the location and time criteria, and that information is communicated to a reservation manager. The variables in the bidding process include the identity of the airline carrier and the departure time (generally including both day and time). In an alternative embodiment, the variables may additionally include the bid price. Upon receipt of a “bid”, the reservation manager queries the airline, or a database comprising a plurality of flight and special fare listings, to determine a flight on which to place the consumer at the special fare/bid price.

An alternative hosted site implementation is taught in U.S. Pat. No. 5,835,896 of Alan S. Fisher, et al, entitled “Method and System for Processing and Transmitting Electronic Auction Information”. In the Fisher, et al system, items from a merchandise database (i.e., an electronic catalog) are offered for bidding, with price being the variable. A customer submits a bid to a bid validator for financial verification, followed by forwarding of the validated bid to an auction manager for a determination as to whether the bid is successful over competing bids.

Yet another auction system having a hosted site is detailed in U.S. Pat. No. 5,890,138 of Paul B. Godin, et al, entitled “Computer Auction System.” In the Godin, et al system, each user (or consumer) is provided with a user designated actuation control to communicate a “bid” for an item being auctioned from a central server site. The central site displays the identity of the item to be auctioned, the current price of the item, the quantity of items available at that current price, and the time remaining during which the item will be offered at the current price. Once a customer bids on an item, or several of the available items, the quantity of available items is decremented and the customer is removed from the auction for a preset time, during which the financial aspects of the transaction are undertaken. Should the financial transaction fail to be completed in the preset time, the quantity of available items is again incremented.

Hosted auctions are effective, but are less than optimal from several perspectives. From a supplier perspective, there is a lack of branding/advertising value for auctions wherein the supplier is not identified until the end of the bidding process; a lack of dynamic inventory and pricing control when entire lots of available inventory must be made available in advance to a hosted site; and a lack of control over who is in the prospective pool of bidders and their qualifications for discounted prices. From a customer perspective, the lack of branding value translates to a so-called “blind bid”, such that there is no opportunity to select or to eliminate potential providers/suppliers from the process. In addition, a non-anonymous bidder may be positioned better than an anonymous bidder in some instances.

It is an object of the present invention to address the shortcomings encountered in the hosted auction systems of the aforementioned patents.

It is another objective of the present invention to provide a system and method whereby a supplier can control all aspects of inventory disposition by controlled inventory depletion.

It is yet another object of the invention to provide the aforementioned controlled inventory depletion on a page of the supplier's existing web site and/or through the supplier's e-mail system.

It is still another objective of the present invention to provide integration of all aspects of the controlled inventory depletion system and method into the supplier's existing yield and revenue management systems.

### SUMMARY OF THE INVENTION

These and other objectives are realized by the present invention wherein a supplier site includes a front-end process for identifying time-sensitive inventory to be offered for selective sale; a sell off component for offering inventory for selective sale and for handling communications with prospective buyers; and a back-end process for automatically integrating the results of the selective sale into the yield and revenue management systems at the supplier site.

### BRIEF DESCRIPTION OF THE DRAWINGS

The present invention will be detailed with specific reference to the appended drawings wherein:

FIG. 1 provides a schematic diagram of networked machines for use with the present invention.

FIG. 2 provides a schematic functional workflow of a Revenue and Yield Management system with which the present invention may be integrated.

FIG. 3 provides a schematic diagram of an alternative implementation of a plurality of networked machines being connected to an exchange component.

FIG. 4 provides a representative process flow diagram for the front-end Inventory Control Management (ICM) system.

FIG. 5 provides a representative process flow diagram for the Offer Preparation system.

FIG. 6 provides a representative process flow for the Auction Management system.

FIG. 7 is a representative screen for a supplier employee entry of information in the front-end offer preparation cycle of the present invention.

FIG. 8 provides a sample screen of a customer interaction in the selective sale process flow of the present invention.

FIG. 9 provides a representative screen for customer entry of information in the selective sale process of the present invention.

### DESCRIPTION OF THE PREFERRED EMBODIMENT

The present invention will be described with reference to the selective sale of airline tickets in order to provide a simple example throughout the description. It is to be understood that the invention, which is ideally implemented in a system which includes a front-end process for identifying time-sensitive inventory to be offered for selective sale, a sell off component for offering inventory for selective sale and for handling communications with prospective buyers, and a back-end process for automatically integrating the results of the selective sale into the yield and revenue management systems at the supplier site, can be applied for a plurality of other goods and services, as well, including but not limited to non-airline carrier services, freight transportation services, hotel and motel reservation services, and the like. The Sell Off and Auction (hereinafter also referred to as “SOA”) invention uniquely provides integration of the supplier's corporate management functions from inventory creation through inventory depletion.

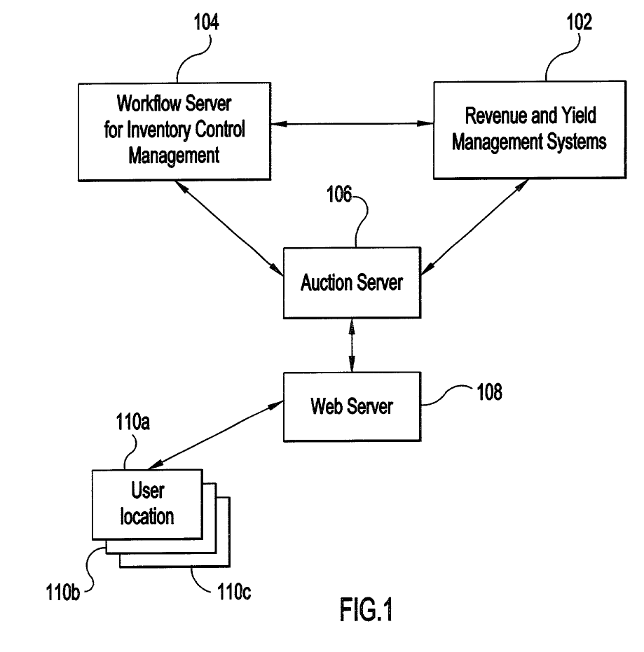

With specific reference to FIG. 1, a first embodiment of the invention will now be detailed. It should be understood that FIG. 1 is a logical diagram and that the functionality of some of the components (for example, reference numerals 102-108) could alternatively be provided in a single server. For purposes of the present description, however, each basic function will be illustrated with a separate component. The supplier has an existing Revenue and Yield Management System, 102, which is the repository of inventory statistics, marketing information, sales data, financial records, forecasting input, etc. The typical Revenue and Yield Management System (hereinafter also referred to as “RYMS”) will have a plurality of databases and a plurality of software programs for operating on data stored in different databases for use by a variety of the supplier's corporate departments. Management of information which is stored in the Revenue and Management System is undertaken by supplier's employees working at one or a plurality of individual workstations (not shown) and uploaded to the RYMS on an “as needed” or on a regular basis.

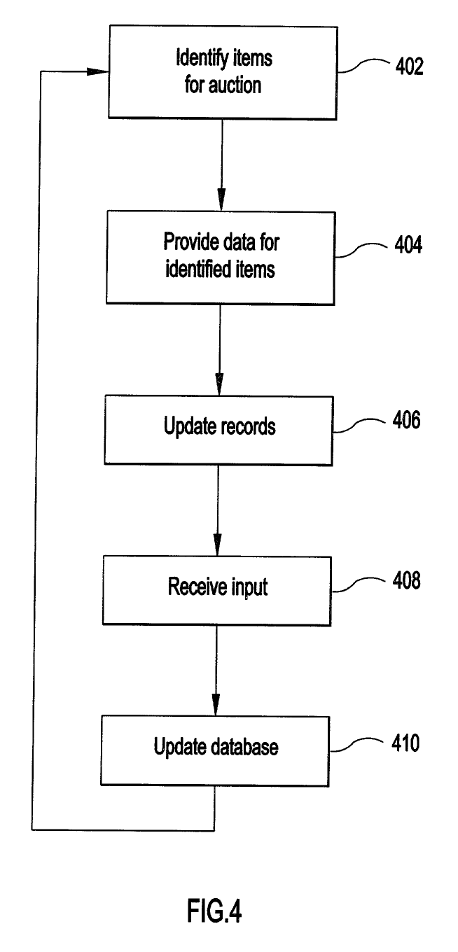

Under the present invention, supplier's employees working in the Inventory Control Management System (hereinafter also referred to as “ICMS” or “ICM”) function will access inventory data to identify inventory items which are to be offered via SOA. The Workflow Server for ICM, illustrated at 104, is the functional component at which the inventory control, further detailed with reference to FIG. 4, will be undertaken.

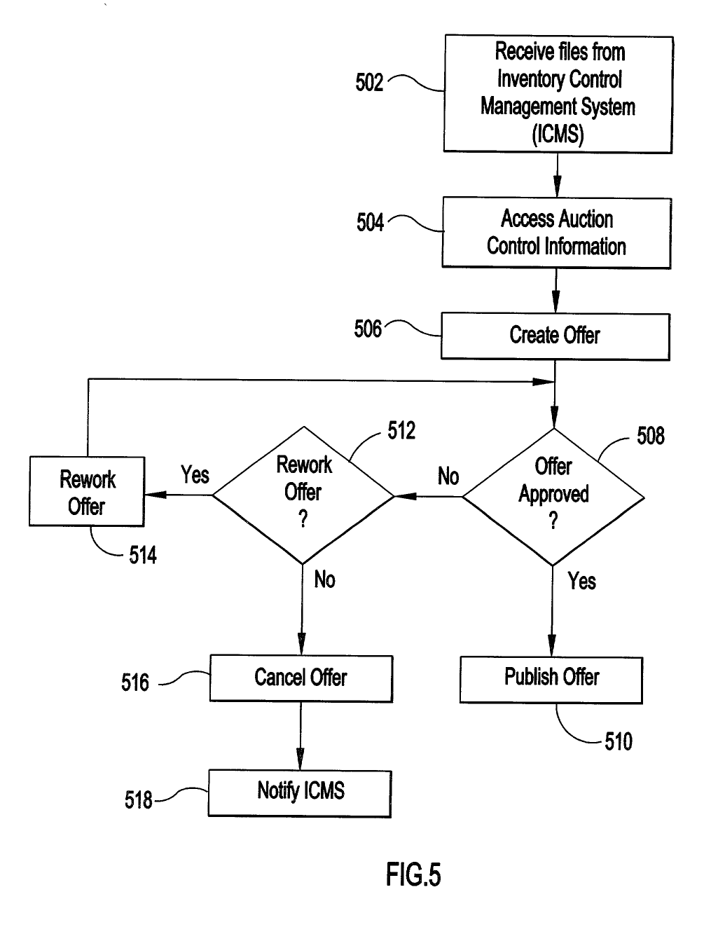

Once an inventory item has been identified for SOA treatment, a SOA offer is prepared for distribution to a general or a demographically-defined target group of potential customers. The SOA offer will include identification of the inventory item as well as parameters for auctioning that particular item. Parameters for auctioning include such details as a minimum price, a set offer price, item details such as a flight number, carrier, and the date and time of the flight, and auction details such as a time window during which the item will be available for sale via the SOA, as well as bidding details such as payment method and maximum time for completing the transaction, all of which is further discussed with reference to the Offer Preparation System workflow of FIG. 5. The offer may be prepared at the Workflow Server 104 and then provided to an Auction Server 106, or may be prepared at the Auction Server based on inventory information which is input from the Workflow Server. The inventory information may include auction information for the particular inventory item(s), or, there may be pre-defined auction information for all or particular classes of corporate inventory.

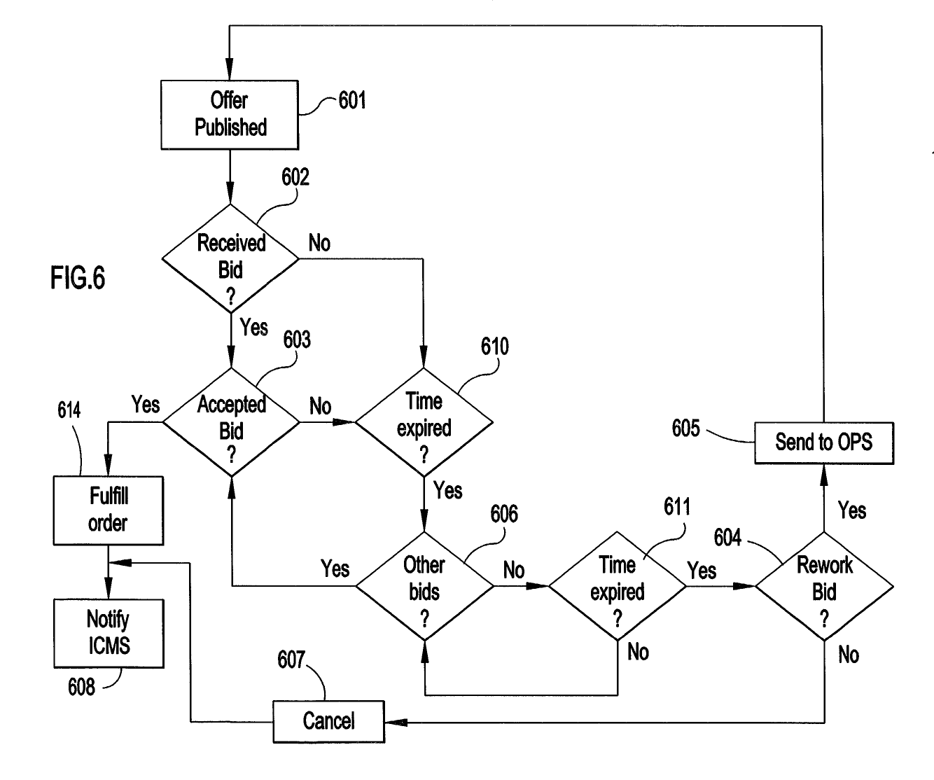

Once the SOA offer has been prepared, it will be provided from the Auction Server 106 to Web Server 108 for distribution to the potential customers. Again, it should be noted that the functions of the Auction Server 106 and the Web Server 108 could clearly be implemented in a single physical component. The function of the Web Server 108 as illustrated is to act as the entity for handling the flow of SOA communications. The Web Server 108 will distribute the SOA offer via the posting of the SOA offer on a particular web page or via distribution of e-mails which include the SOA offer. Depending upon the definition of the target audience of customers, there may be only a selected number of potential bidders (e.g., some or all of the supplier's corporate employees; or, a set of subscribers) who will be recipients of the SOA offer via e-mail or via selective access to a particular SOA web page. Customers at user locations, illustrated at 110a-110c, will evaluate the SOA offer and provide bids back to the Web Server 108. The bids will then be provided to the Auction Server 106 for evaluation as detailed below with reference to FIG. 6. The results of the bid evaluation(s) will be provided to the User locations 110a-110c via the Web Server 108 as well as to the Workflow Server 104 via the Auction Server 106. Offer fulfillment will be undertaken and the relevant ICM information updated both at the Workflow Server 104 and the RYMS 102.

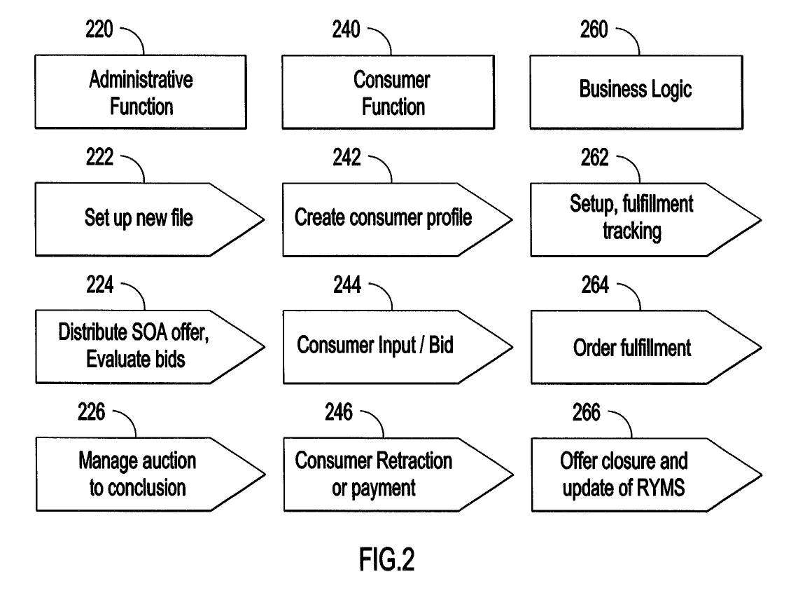

FIG. 2 provides a schematic functional workflow of a Revenue and Yield Management system with which the present invention may be integrated. As mentioned above, Revenue and Yield Management System would ordinarily include such components as accounting software, forecasting software, inventory tracking software, sales tracking software, production software and the respective databases. From the perspective of the SOA invention, three main functions perform operations related to disposition of the inventory by SOA. The inventory disposition is effectively broken down into SOA initiation roles (222, 242, 262), auction roles (224, 244, 264) and SOA termination roles (226, 246, 266). The Administrative Function, shown at 220, performs the SOA initiation function of identifying inventory for SOA treatment and setting up the SOA offer, collectively referred to as “set up new file” at 222. The Consumer function 240 performs an initiation function of creating a consumer/customer profile at 242, which may include pre-defining fields such as name, address, billing information, etc. Initiation from the perspective of the Business Logic 260 includes setting up fulfillment tracking at 262. In operation, the auction roles include the administrative function of distributing the SOA offer at 224, the consumer function of inputting one or a plurality of bids at 244, and the business function of order fulfillment at 264. From the perspective of SOA termination, the administrative function includes managing the auction to its conclusion at 226, which conclusion may be termination based on a successful sale via auction or termination by SOA offer expiration without successful completion. The consumer termination functions at 246 include either completion of the transaction or retraction of the bid. The business logic termination functions include offer closure and updating of the RYMS at 266.

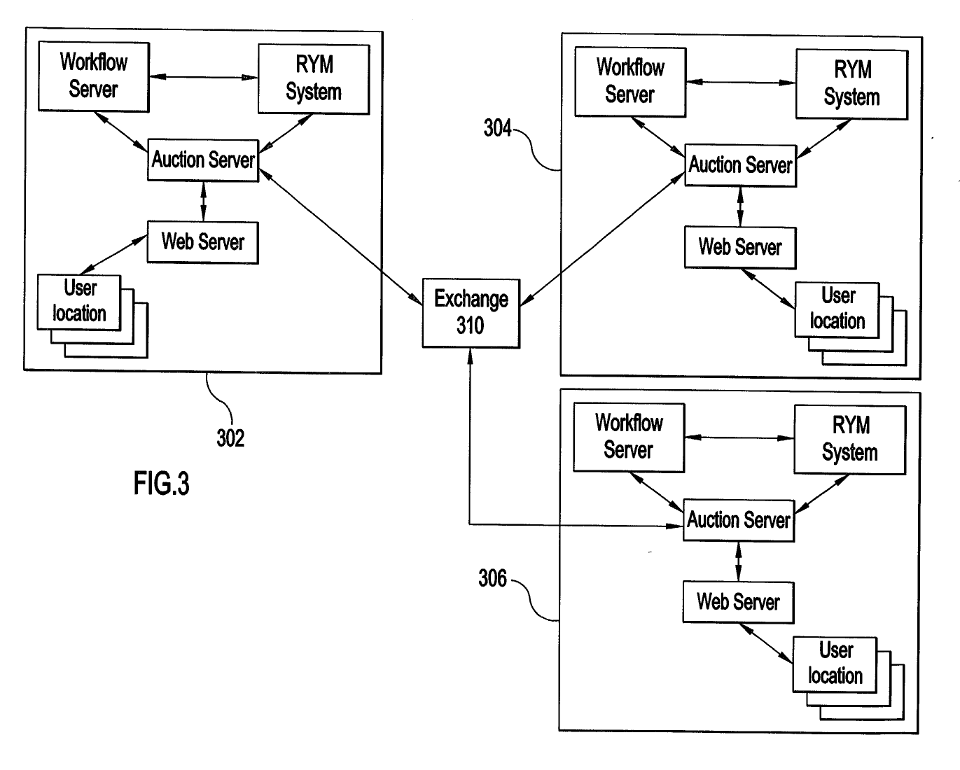

A key feature of the present invention is that the supplier of the time-sensitive inventory controls the inventory disposition from start to finish. Advantages of the supplier-controlled SOA include implicit brand/source identification (e.g., customers know that they are bidding on only flights provided by the XYZ Airline), strict inventory management including automatic updating of the RYMS, and control of the pool of potential SOA customers. It may, nonetheless, however, be advantageous to “advertise” the SOA offers to a pool of potential customers. FIG. 3 provides a schematic diagram of an alternative implementation of the invention wherein a plurality of networked machines are connected to an exchange component, whereby related inventory for a plurality of brands may be managed via a central component. For example, a corporation may have several brands of consumer product, such as household cleaners, as well as one or more brands which are marketed to industry customers, such as industrial-strength cleaners. If industry customer can access a single exchange 310, all industry suppliers will be able to dispose of inventory more effectively. Similarly, an airline corporation may have several operating units including one which operates regional “puddle-jumpers”, a fleet of domestic freight carriers, a fleet of domestic passenger planes, and an international carrier. Some of the operating units may already have access to an industry exchange (particularly in the instance of freight handling) which provides the most effective vehicle for advertising SOA offers to the appropriate target audience. Therefore, a plurality of SOA suppliers 302, 304 and 306 could provide their SOA offers to an exchange site 310 at which the SOA offers will reach their target audience. Inventory tracking will be preserved, since it is still the Auction Server at the supplier site which will manage the auction and the disposition of the inventory.

An in-house executive or automatic tracking system will be charged with the responsibility of consulting the inventory database to determine if available inventory should be offered via the SOA (Sell Off and Auction) system. The inventory determination of FIG. 4 will be followed by an offer preparation process of FIG. 5, which in turn is followed by control and offer handling by the auction management database and auction logic as shown in FIG. 6, with optional posting of the SOA offers at an Exchange location.

FIG. 4 provides a representative process flow diagram for the front-end Inventory Control Management (ICM) system of the present invention. The ICM must first identify items which will be given SOA treatment at step 402. The basis on which to designate items for SOA treatment will vary depending upon corporate standards, the nature of the inventory, and the time-sensitivity of the inventory. In addition, there may be a “built-in” inventory tracking feature which will provide for automatic identification of the items. For example, initial inventory records may include a time-sensitivity entry such as an expiration date and/or a pre-expiration last sale date. A component of the inventory control database may then be programmed to conduct a regular (e.g., daily or weekly) review of the time-sensitivity entries and to automatically flag the records for items which should be considered for SOA treatment based on pending expiration. Once items have been identified for SOA treatment, the ICM system will provide data about the identified items at step 404 for offer preparation. The provided data may include not only item-specific data, such as flight number, aircraft class, and flight date and time, but also auction-specific data, such as minimum bid value, target audience, and date(s) for SOA availability. The ICM should, ideally (although optionally) update the item record, at step 406, to indicate that the item is being offered by SOA. Once the ICM has provided the information for offer preparation and SOA treatment, the ICM will wait to receive input regarding the auction. Input which will be received at 408 includes such detail as whether the SOA was successfully completed and the inventory disposed of, whether the offer was canceled, the price (if the inventory management system also includes a financial tracking component), customer identification or demographic information for future inventory and/or SOA planning, etc. Depending on the breakdown of corporate functions, some or all the auction input may be provided for use by a plurality of different corporate functions as well. Based on the exact nature of the update data, the ICM system will update its database accordingly at step 410. Should the auction input indicate that the inventory item was not successfully disposed of, the ICM system may start the process again at 402 with the step of again identifying that inventory item for SOA treatment. The auction-specific details may, however, be revisited in order to make the item more attractive for auction customers. For example, as the expiration date approaches, the minimum acceptable bid value may be decreased and that new information provided at step 404.

FIG. 5 provides a representative process flow diagram for the Offer Preparation system. Once the item-specific data has been provided for offer preparation, the process flow of FIG. 5 commences. The Offer Preparation System (hereinafter also referred to as “OPS”) receives the input from the ICMS at 502, followed by accessing auction-specific control information at step 504. As noted above, the data provided from the ICMS may already include auction-specific information which will be accessed by the OPS. Alternatively, the OPS may access pre-defined corporate standards regarding the auctioning of all or specific inventory items. In addition, it may be advantageous to provide the OPS with the functionality for dynamically determining the auction parameters, with or without interaction with the ICMS. For example, the OPS may engage in an exchange with inventory control personnel to obtain authorization to change the minimum bid price. The OPS may also include tracking software for keeping records on past transactions, and may then access its historical data as a basis for setting the minimum bid price or for identifying the appropriate target audience for the SOA offer. Once the OPS has all of the item-specific and auction-specific data, the OPS will create the offer at step 506. An additional set of steps may be included wherein some corporate review of offers is conducted prior to publishing the offer. Those optional steps are indicated in FIG. 5 wherein a determination is made at 508 as to whether the offer has been approved. If approved, the offer is published at 510. If the offer is not approved, as determined at decision box 508, a determination is made at 512 as to whether the offer should be reworked or not. These additional steps are provided to allow the relevant corporate functions the ability to intercept offers for whatever reasons they might deem necessary or appropriate. If reworking is not authorized, as determined at decision box 512, the offer is canceled at 516 and the auction input is provided to the ICMS (and other designated corporate destinations as needed) at 518. If reworking of the offer is authorized at 512, the offer is reworked at 514 (e.g., minimum bid price changed) and again provided for approval at 508 and ultimately for publication at 510. Publication of the offer may comprise one or more of: providing the SOA offer for distribution by the Auction Management System (AMS), the functions of which are detailed in FIG. 6; posting the SOA offer on a web site with notification to the AMS; or, transmitting a plurality of SOA offer e-mails to the target audience.

FIG. 6 provides a representative process flow for the Auction Management System (hereinafter also referred to as “AMS”). Starting with the point at which the SOA offer is published at 601, the AMS awaits bid input from customers. The AMS will determine if a bid has been received at step 602. Since SOA offers will generally be time limited, the AMS may periodically poll to determine if a bid has been received. If no bids are received, as determined at 602, and the time has expired, as determined at 610, the AMS will determine at 604 if the SOA offer should be reworked. This determination may be made unilaterally (e.g., based on corporate standards, historical data, etc.) or may require input from other corporate functions. When it is determined that the SOA offer should be reworked, at 604, the SOA offer is returned to the OPS at 605 for reworking and, once the revised SOA offer is received back from OPS, it is re-published at 601. If reworking is not deemed appropriate, the AMS cancels the offer at 607 and notifies the ICMS (and other entities as appropriate) at 608.

If a bid has been received at 602, the AMS proceeds to evaluate the bid using its predefined bid evaluation criteria (e.g., does the bid meet or exceed the minimum bid price; is the bidder a member of the target audience; is payment authorized by the bidder's payment agent; is payment authorization received within a preset time period; etc.) at step 603 and determines whether or not the bid is accepted. If the bid is accepted, the order fulfillment is set at 614 and ICMS is notified at 608. If the bid is not accepted, as determined at 603, the AMS checks to see if the time has expired for the SOA offer at step 610. If time has expired, the AMS may again consider at 604 whether the bid should be reworked and may accordingly either send the bid back to OPS at 605 or cancel the SOA offer at 607. If the SOA offer time has not expired, the AMS determines whether any other bids have been received at 606. If no other bids have been received, the AMS again considers at 611 if the SOA offer time has expired and either again waits for other bids at 606 or considers rework at 604. If other bids have been received, the AMS will evaluate the bids at 603 as discussed above. It is to be noted that the presently preferred embodiment will time-stamp incoming bids and handle the bids on a first come, first serve basis. The present description does not detail a bid evaluation function wherein competing bids are considered and a winning bid chosen as the accepted bid from among the competing bids, although such a feature could clearly be incorporated into the system without departing from the scope of the invention as set forth in the appended claims.

Three primary types of auction are readily implemented using the present inventive system and method. A Fixed Auction comprises an offer at a fixed price where no variables are undefined. The two types of auctions which require submission of bids for undefined variables include Dutch and English auctions. For each auction type, different information must be input at the supplier site in order to prepare the SOA offer. The input of information which can be used in preparing and conducting the SOA includes item-specific inventory information which is already entered into the inventory control system and auction-specific information. Examples of the type of records which may be maintained for use in the SOA system and method for auctioning airline inventory follow. A PRODUCT, PRODUCTEXT, BIDRULE, and AUCTINFO record together represent one flight opportunity for auction for a Dutch or English auction. A PRODUCT, PRODUCTEXT, and PRODPRCS record together represent one flight opportunity for fixed price auction.

PRODUCT Record

PRODUCT Record

#PRODUCT;<product.prnbr>;<product,prnbr>;<productprsdesc>;
<product.prldescl>;<product.prldesc2><product.prldesc3>.<product.
prthb>;<product.prfull>;<product.prpub>;<product.prwght>;<product.
prwmeas>;<product.prlngth>;<product.prwidth>;<product.prheight>;
<product.prsmeas>;<prspcode.pscode>;<prspcode.psspmthd>;<product.
prpcode>;<product.prurl>;<product.prvent>;<product.pravdate>;<product.
prspecial>;<product.prstmp>;<product.prfield1>;<product.prfield2>;
<product.prfield3>;<product.prfield4>,<product.prfield5>;<product.
prdconbr>
Product.prnbr - char 64 - product number - must be unique for SOA
the suggestion is that this could be a unique Notes ID associated
with each “opportunity”/ OppNum /
Product.prsdesc - varchar 254 - short description - Flight number /
Flight_No /
Product.prldesc1 - long varchar - long description - Departure
airport / Origin /
Product.prldesc2 - long varchar - long description - Arrival
airport / Destination / Product.prldesc3 - long varchar -
long description - Cabin / Class /
Product.prthmb - char 254 - thumbnail image path -N/A - image of
product
Product.prfull - char 254 - full image path - N/A - image of
product
Product.prpub - smallint - displayed to public (0 = no, 1 = yes,
2 = marked for deletion) NOTE: would assume that we would use 2
for the Notes interface to remove “opportunities” from the
Net.Commerce database / mass import always run in update mode /
Product.prwght - num (15,4) - product weight - N/A for airlines
Product.prwmeas - num (15,4) - unit of measurement for weight -
N/A
Product.prlngth- num (15,4) - length - N/A
Product.prwidth- num (15,4) - width - N/A
Product.prheight - num (15,4) - height - N/A
Product.prsmeas - char 20 - unit of measurement for height,
width, and length - N/A
Prspcode.pscode - char 5 - product ship code (from prspcode
table) - N/A
Prspcode.psspmthd - char 2 - product ship method (from prspcode
table) - N/A
Product.prpcode - char 25 - product taxation code ( foreign key
to taxprcode table ) - N/A
Product.prurl - varchar 254 - URL for softgoods N/A
Product.prvent - integer - number of items in stock - null means
product is not stocked - suggestion for SOA Airline Industry is
total number of “seats” / SeatsAvail /
Product.pravdate - timestamp for product availibility - prior to
departure date
Product.prspecial - char 4 - (S sale, A = auction) - SOA
supplied / S if AuctionType is Fixed, A otherwise /
Product.prstmp - timestamp - date and time product was last
updated - N/A - will default to current time and date
Product.prfield1 - integer - merchant customization - N/A
Product.prfield2 - integer - merchant customization - N/A
Product.prfield3 - nun (15,2) - merchant customization - N/A
Product.prfield4 - varchar 254 - merchant customization - SOA -
Auction Group - unique identifier for any offer - used to “group”
opportunities/flights for user presentation/selection / OfferNum -
the key assumption being that all opportunities within an offer
participate in the same type of auction /
Product.prfield5 - varchar 254 - merchant customization - N/A
Product.prdconbr - integer - discount - ( foreign key to disccode
table ) - N/A

PRODUCTEXT Record

#PRODUCTEXT; <product.prnbr>;<productext.pedstmp>;<productext.
peastmp>;<productext.peequip>NOTE: this table is added by IGS GAD
for SOA
Productext.pedstmp - timestamp - SOA departure date / DepDate,
DepTime /
Productext.peastmp - timestamp - SOA arrival date / ArrivalDate,
ArrivalTime -
Product.peequip - varchar 64 - SOA equipment / Equipment /

BIDRULE Record

This record required for each product(f light opportunity) if
product.prspecial is “A” wherein “A” means an English or Dutch
auction type.
#BIDRULE;<bidrule.brrefnum>;<bidrule,brminval>;>bidrule.
brminquant>;<bidrule.brvalrange>;<bidrule.brvalincr>;<bidrule.
brquantrange>;<bidrule.brquantincr>;<bidrule.brfield1>;<bidrule.
brfield2>;<bidrule.brfield3>;<bidrule.brautype>
Bidrule.brrefnum - integer not null - bid rule reference number -
SOA - unique ID - also entered as auctinfo.aubdrule / OppNum /
bidrule.brminval - num(15,2) - minimum bid value / MinBid_E,
MinPrice_D /
bidrule.brminquant - num(15,2) - minimum bid quantity /
MinBidIncr_E, BidDecr_D /
bidrule.brvalrange - varchar 254 - bid value range vector, this
allows the use of ranges to determine bid increments (ex. mm
price = 100-150 bid increment = 10, mm price 151-200 bid
increment = 20) This holds the ranges and the following attribute
holds the increments.
Bidrule.brvalincr - varchar 254 - bid value increment vector
Bidrule.brquantrange - varchar 254 - bid quantity range vector,
allows use of ranges to determine quanitity bid increments (ex: a
range of 10-50 may require to bid for quantities of 5 while
bids for 50-100 may require bid for quantities of 10 (60, 70, 80
etc . . . ))
Bidrule.brquantincr - varchar 254 - bid quantity increment vector
Bidrule.brfield1 - integer - merchant customization
Bidrule.brfield2 - num(15,2) - merchant customization
Bidrule.brfield3 - varchar 254 - merchant customization
Bidrule.brautype - char 4

AUCTINFO Record

This record required for each product (flight opportunity) if
product.prspecial is “A” as above.
#AUCTTNFO;<product.prnbr>;<auctinfo.autype>;<auctinfo.austatus>;
<auctinfo.auquant>;<auctinfo.auminbid>;<auctinfo.aucur>;<auctinfo.
auruletype>;<auctinfo.austtim>;<auctinfo.auendtim>;<auctinfo.
aucurendtim>;<auctinfo auduration>;<auctinfo.audepost>;<auctinfo.
aurulemacro>;<auctinfo.auprdmacro>;<auctinfo.audesc>;<auctinfo.
aubestbid>;<auctinfo.austartprice>;<auctinfo.aucurquant>;<auctinfo.
aucurprice>;<auctinfo.auupdtime>;<auctinfo.aufield1>;<auctinfo.
aufield2>;<auctinfo.aufield3>;<auctinfo.aufield4>;<auctinfo.aufield5>;
<auctinfo.aufield6>;<auctinfo.aupricing>;<auctinfo.auhighbid>;
<auctinfo.auhistorynum>;<auctinfo auversionnum>;<auctinfo.
auversiondesc>
Auctinfo.autype - char 4 - auction type ( O = open cry, SB =
sealed bid, D = dutch ) - SOA dependant on airline requirement
don't fit English, D - Dutch)???? /
Auctinfo.austatus - char 4 - auction status ( BC = bidding
closed, SC = settlement closed, C =current, F = future ) - SOA
always “F” / Constant / Yes, will be changed to the other values
by Net.Commerce during auction.
Auctinfo.auquant - decimal (15,2) - SOA number of items for
auction / InitQty /
Auctinfo.auminbid - decimal (15,2) - SOA minimum opening bid /
MinBid_E for English, MinPrice_D for Dutch /
Auctinfo.aucur - char 10 - SOA ISO currency price is expressed in /
USD, a constant-not in db /
Auctinfo.auruletype - integer - rules for auction closing ( 1 =
closed at fixed tine, 2 = closed on time elapsed after last bid,
3 = 1 OR 2 (whichever happens first), 4 = 1 AND 2 ) / ?? /
Auctinfo.austtim - timestamp - scheduled auction start /
OfferStartD, OfferStartT /
Auctinfo.auendtim - timestamp - scheduled end time end time /
OfferExD, OfferExT /
Auctinfo.aucurendtim - timestamp - current time of auction
closing (used for conditions specified for auruletype - N/A for
mass import)
Auctinfo.auduration - timestamp - duration past last bid for
auction to close
Auctinfo.audepost - decimal (15,2) - deposit forfeited if items
not purchased
Auctinfo.aurulemacro - char 254 - macro file name for each
auction rule - SCA default auctinfo.d2w
Auctinfo.auprdmacro - char 254 - new product display macro - will
we use this - SOA default tempauct.d2w
Auctinfo.aubdrule - integer - SOA - bidrule number equal to
<bidrule.brrefnum>
Auctinfo.audesc - varchar 254 - auction rule description - N/A
Auctinfo.aubestbid - char 36 - ( foreign key references bidrule
table
Auctinfo.austartprice - decimal (15,2) - starting price (dutch) /
StartBid_D /
Auctinfo.aucurquant - decimal (15,2) - current quantity (dutch) -
no entry, dynamically updated
Auctinfo.aucurprice - decimal (15,2) - current price (dutch) - no
entry, dynamically updated
Auctinfo. auupdtime - timestamp - duration for dutch price update
Auctinfo.aufield1 - integer - merchant customization
Auctinfo.aufield2 - integer - merchant customization
Auctinfo.aufield3 - decimal (15,2) - merchant customization
Auctinfo.aufield4 - decimal (15,2) - merchant customization
Auctinfo.aufield5 - varchar 254 - merchant customization
Auctinfo.aufield6 - varchar 254 - merchant customization
Auctinfo.aupricing - char 4 - N/A
Auctinfo.auhighbid - char 36 - N/A
Auctinfo.auhistorynum - integer - N/A
Auctinfo.auversionnum - integer - N/A
Auctinfo.auversiondesc - char 254 - N/A

PRODPRCS Record

This record required for each product(f light opportunity) if
product.prspecial is “S” where “S” represents a fixed auction
type.
#PRODPRCS;<product.prnbr>;<shopgrp.sgname>;<prodprcs.ppprc>;
<prodprcs.ppcur>;<prodprcs.
pppre>;<prodprcs.ppdeffs>;<prodprcs.ppdefff>;<prpdprcs.
ppfield1>; <prodprcS.ppfield2>
Shopgrp.sgname - integer - shopper group reference number - SOA
N/A
Prodprcs.ppprc - num (15,2) - the price - SOA price / Price_F
Prodprcs.ppcur - char 10 - ISO currency - SOA required (i.e. USD) /
USD, a constant-not in db /
Prodprcs.pppre - precedence for this price - SOA N/A
Prodprcs.ppdeffs - timestamp - date price is effective - defaults
to currtime - SOA ?/
OfferStartD, OfferStartT /
Prodprcs.ppdefff - timestamp - date price expires - SOA ? /
OfferExD, OfferExT /
Prodprcs.ppfield1 - char 30 - merchant customization - SOA N/A
Prodprcs.ppfield2 - char 1 - merchant custemization - SOA N/A

PRODPRCS Record

This record required for each product (flight opportunity) if product.prspecial is “S” where “S” represents a fixed auction type.

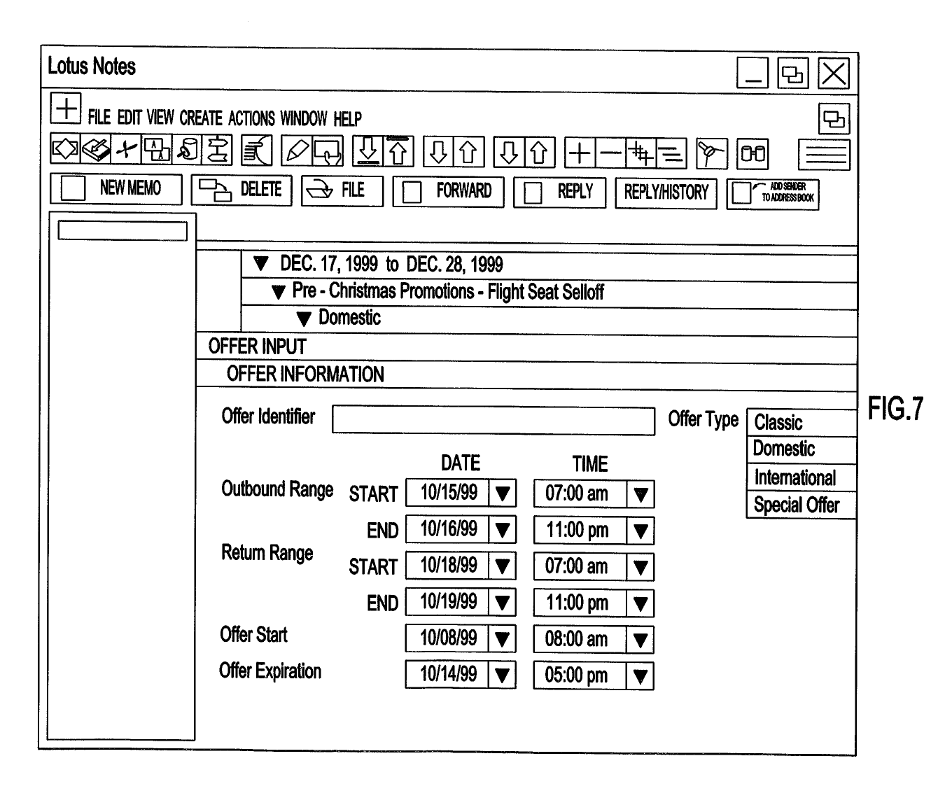

FIG. 7 shows a representative screen for a supplier employee entry of information in the front-end offer preparation cycle of the present invention. The example is shown using a Lotus Notes interface, which is particularly attractive since it facilitates use of e-mail as a delivery format to preferred or target customers.

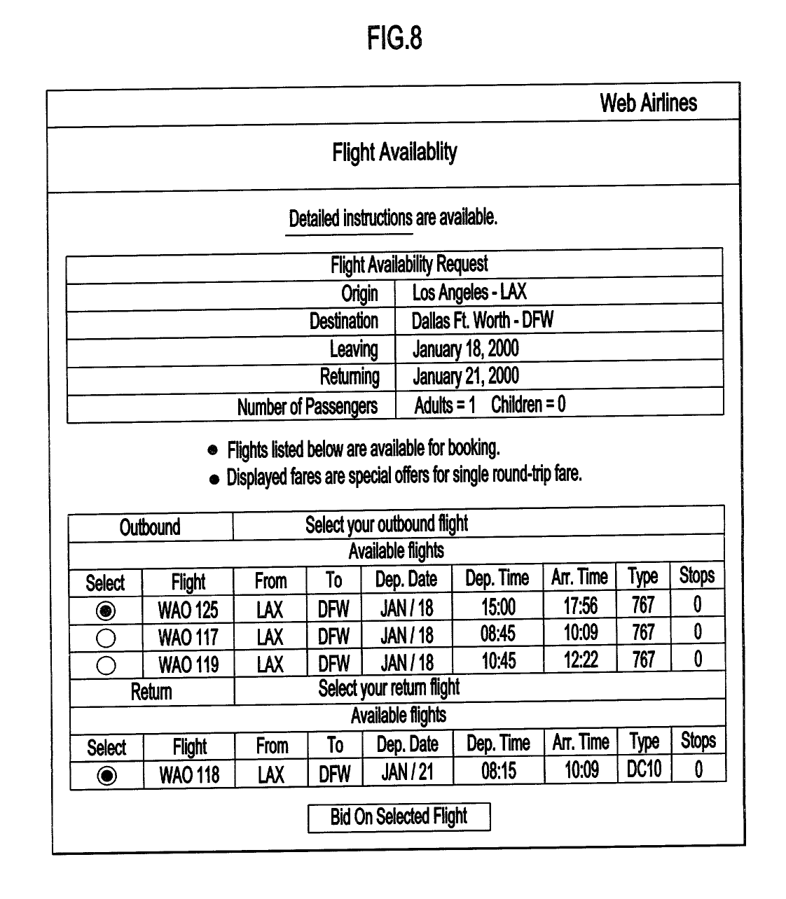

FIG. 8 provides a sample screen of a customer interaction in the selective sale process flow of the present invention. A customer is presented with a branded view of available offering. A user can solicit information or be presented with tailored offerings, as noted above.

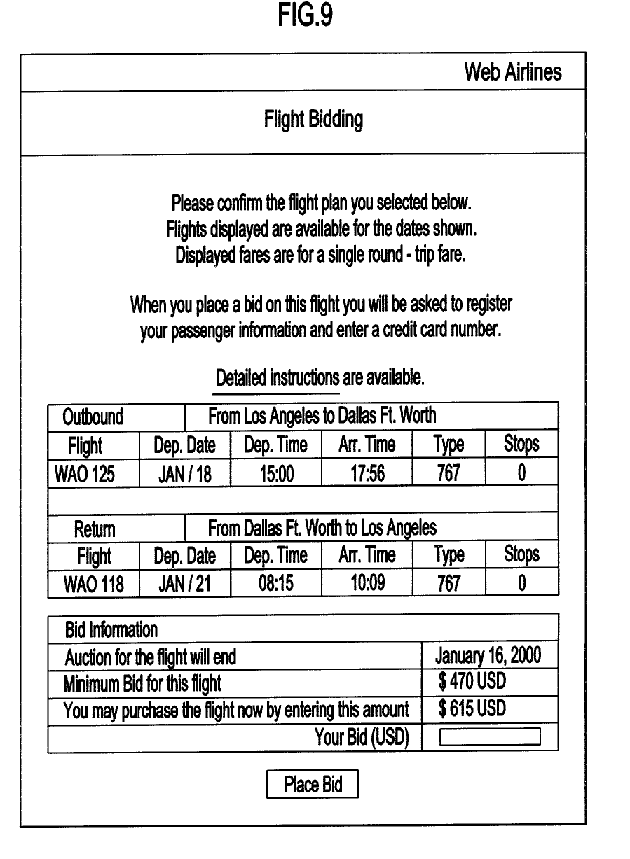

FIG. 9 provides a representative screen for customer entry of information in the selective sale process of the present invention. The auction logic handles the “negotiation” with the customer for any of a Dutch, English or other auction format.

The type of information which is imported from the Yield and Revenue Management system when inventory has been designated for SOA processing is ideally a file which can be directly input to the auction logic using a mass import utility. The ease of transfer of information between the Yield and Revenue Management system and the auction logic will allow virtually instantaneous updating of relevant databases, and consequent efficiencies in both the identification of future inventory for SOA handling and the related inventory processing at the back end of the inventory control process. The file formats and file record information detailed above and in the following pages assumes a flight inventory SOA implementation, although clearly other inventory is contemplated (as evidenced by such entries as “merchant customization” in the product record. In addition, as noted above, alternative file formats will be chosen depending upon which SOA implementation is selected for disposition of the subject inventory. For example, if the inventory is to be offered at a set price, a bidrule file is unnecessary. The Massimport format for an SOA in the Airline Industry follows:

#VERSION
#STORE

| | |
|---|---|
| #PRODUCT (product.prspecial = “A”) | ′“A” = 4 |
| records in record group | |
| #PRODUCTEXT | |
| #BIDRULE | |
| #AUCTINFO | |
| #PRODUCT (product.prspecial = “A”) | ′“A” = 4 |
| records in record group | |
| #PRODUCTEXT | |
| #BIDRULE | |
| #AUCTINFO | |
| #PRODUCT (product.prspecial = “S”) | ′“S” = 3 |

records in record group
#PRODUCTEXT
#PRODPRCS
. . .
A Massimport example for an SOA in the Airline Industry follows:
#VERSION;32
#STORE;BillS Low Budget Airline
#BIDRULE;4;100;1;;;;;;;;
#PRODUCT;7;;BLBA1007;LEX;ORD;Coach;;;1;;;;;;;;;;;50;;A;;;;;AG1;;
#PRODUCTEXT;7;2000-09-20-10.00.00.000000;2000-09-20-11.00.00.00
0000;B777
#AUCTINFO;7;O;F;10;;USD;1;2000-02-01-00.00.00.000000;2000-03-
02-00.00.00.000000;;;;auctinfo.d2w;tempauct.d2w;4;;;;;;;;;;;;;;;;;
#BIDRULE;5;100;1;;;;;;;;
#PRODUCT;8;;BLBA1008;ORD;LEX;Coach;;;1;;;;;;;;;;;60;;A;;;;;AG1;;
#PRODUCTEXT;8;2000-09-30-16.00.00.000000;2000-09-30-17.00.00.00
0000;B777
#AUCTINFO;8;O;F;10;;USD;1;2000-02-01-00.00.00.000000;2000-03-
02-00.00.00.000000;;;;auctinfo.d2w;tempauct.d2w;5;;;;;;;;;;;;;;;;;
#BIDRULE;6;100;1;;;;;;;;
#PRODUCT;9;;BLBA1007;LEX;ORD;Coach;;;1;;;;;;;;;;;50;;A;;;;;AG2;;
#PRODUCTEXT;9;2000-09-21-10.00.00.000000;2000-09-21-11.00.00.00
0000;B777
#AUCTINFO;9;O;F;10;;USD;1;2000-02-01-00.00.00.000000;2000-03-
02-00.00.00.000000;;;;auctinfo.d2w;tempauct.d2w;6;;;;;;;;;;;;;;;;;
#BIDRULE;7;100;1;;;;;;;;
#PRODUCT;6;;BLBA1008;ORD;LEX;Coach;;;1;;;;;;;;;;;60;;A;;;;;AG2;;
#PRODUCTEXT;6;2000-09-30-16.00.00.000000;2000-09-30-17.00.00.00
0000;B777
#AUCTINFO;6;O;F;10;;USD;1;2000-02-01-00.00.00.000000;2000-03-
02-00.00.00.000000;;;;auctinfo.d2w;tempauct.d2w;7;;;;;;;;;;;;;;;;;
#PRODUCT;9;;BLBA1008;ORD;LEX;Coach;;;1;;;;;;;;;;;60;;S;;;;;AG3;;
#PRODUCTEXT;9;2000-09-30-16.00.00.000000;2000-09-30-17.00.00.00
0000;B777
#PRODPRCS;9;;233.95;USD;;;2000-09-30-24.00.00.000000;;

It is to be noted that the product price table, PRODPRCS, will have a required entry if a PRODUCT record is not an auction product but a “standard” offered product and there may be an additional table that will function as an extension to the BIDRULE table for additional Dutch auction control purposes. This table will be updated via massimport. As can be seen from the foregoing examples, the formatting of the files facilitates ease of transfer of information among the supplier's systems, making the update process “painless” and effective.

The invention has been described with reference to several specific embodiments. One having skill in the relevant art will recognize that modifications may be made without departing from the spirit and scope of the invention as set forth in the appended claims.

Having thus described our invention, what we claim as new and desire to secure by Letters Patent is:

1. A system for providing controlled inventory depletion of time-sensitive inventory from a supplier site having at existing business management systems comprising:
a front-end process for identifying time-sensitive inventory to be offered for selective sale;
a sell off component for offering inventory for selective sale and for handling communications with prospective buyers; and
a back-end process for automatically integrating the results of the selective sale into the management systems at said supplier site.

2. The system of claim 1 wherein said sell off component comprises:
an inventory control component for tracking items of inventory and maintaining records therefor;
an offer preparation component for preparing offers for inventory sell off; and
a sell off management component.

3. The system of claim 2 wherein said inventory control component comprises means for automatically identifying time-sensitive inventory for sell off.

4. The system of claim 3 wherein said inventory control component comprises means for updating records of items which are identified for sell off.

5. The system of claim 3 wherein said inventory control component is adapted to communicate item-specific information to said offer preparation component.

6. The system of claim 5 wherein said offer preparation component is adapted to create at least one sell off file based on said item-specific information.

7. The system of claim 5 wherein said offer preparation component comprises means for dynamically creating at least one sell off file comprising item-specific information and auction control data.

8. The system of claim 5 additionally comprising an auction tracking component for maintaining historical auction data.

9. The system of claim 8 wherein said offer preparation component comprises means for dynamically creating at least one sell off file comprising item-specific information and said historical auction data.

10. The system of claim 2 further comprising means for advertising said offers for sell off.

11. The system of claim 10 wherein said means for advertising said offers for sell off comprises a web browser for posting offers on at least one web page.

12. The system of claim 10 wherein said means for advertising said offers for sell off comprises an electronic mail server for distributing said offers via electronic mail.

13. A method for providing controlled inventory depletion of time-sensitive inventory comprising:
a front-end process identifying time-sensitive inventory to be offered for selective sale;
a sell off component offering inventory for selective sale and for handling communications with prospective buyers; and
a back-end process automatically integrating the results of the selective sale into the yield and revenue management systems at the supplier site.

14. The method of claim 13 wherein said offering inventory comprises the steps of:
identifying items of inventory for sell off;
preparing offers for inventory sell off; and
managing the sell off of said inventory.

15. The method of claim 14 wherein said identifying items comprises automatically identifying time-sensitive inventory for sell off.

16. The method of claim 15 further comprising updating records of items which are identified for sell off.

17. The method of claim 15 further comprising communicating item-specific information to said offer preparation component.

18. The method of claim 17 wherein said offer preparing comprises creating at least one sell off file based on said item-specific information.

19. The method of claim 17 wherein said offer preparing comprises dynamically creating at least one sell off file comprising item-specific information and auction control data.

20. The method of claim 17 additionally comprising maintaining historical auction data.

21. The method of claim 20 wherein said offer preparing comprises dynamically creating at least one sell off file comprising item-specific information and said historical auction data.

22. The method of claim 14 further comprising the step of advertising said offers for sell off.

23. The method of claim 22 wherein said advertising said offers for sell off comprises posting offers on at least one web page.

24. The method of claim 22 wherein said advertising said offers for sell off comprises distributing said offers via electronic mail.

25. The method of claim 22 further comprises identifying a target group for said offers and wherein said advertising comprises providing electronic mail only to said target group.

26. A program storage device readable by machine tangibly embodying a program of instructions executable by the machine for performing a method for providing controlled inventory depletion of time-sensitive inventory, said method comprising the steps of:
a front-end process identifying time-sensitive inventory to be offered for selective sale;
a sell off component offering inventory for selective sale and for handling communications with prospective buyers; and
a back-end process automatically integrating the results of the selective sale.
